(19) United States
(12) Patent Application Publication
(10) Pub. No.: US 2003/0214601 A1
(43) Pub. Date: Nov. 20, 2003

(54) Remote-control device for video camera

(76) Inventor: Siltex Peter Yuen, San Jose, CA (US)

Correspondence Address: Siltex Peter Yuen, 2765 Henessy Drive, San Jose, CA, 95148, US

(21) Appl. No.: 10/142,069

(22) Filed: May 9, 2002

(51) Int. Cl. H04N 5/225; H04N 5/232; H04N 7/18

(52) U.S. Cl. 348/375; 348/211.99; 348/143

(57) ABSTRACT

A remote control device, which includes conventional remote system and wireless remote system, to control a handheld video camera without directional limitation. Generic handheld video camera controller are using IR signals which require the signal source to be pointing at the video camera IR receiver inlet lens in order for the system to facilitate the remote control functions. This device provides users a remote controlling means to control the video camera from a distance away with a physical wall or blockage in between. This device turns most of the available handheld video cameras into quality surveillance video cameras. This device makes surveillance video system much more affordable. Since this device is a universal device, it works with most generic video cameras of different brands; users can choose their favorite brand to be their surveillance camera. This device is covered with a rain shield and is suitable for both indoor and outdoor usage.

### FIELD OF INVENTION

The present invention relates generally to portable video camera control equipment, and more particularly to remote control of personal handheld video camera accessory.

### BACKGROUND OF THE INVENTION

Personal handheld video camera has been very popular for many years. Today, there is a lot of different brand name manufacturers and at very low prices. However, these video cameras are not being used as general surveillance video camera yet. The reason is that all handheld video cameras are using IR (infrared) to transmit signals between the controller and the camera unit. IR (infrared) is a directional dependent function. The light source has to be pointing at the receiving function components of the camera unit in order for the camera to be able to detect the IR signals. The cost of surveillance video cameras will go down substantially if generic handheld video cameras can be controlled remotely independent from the sole directional IR function controller.

Thus there is a need for a remote device to be able to control a generic video camera independently from the sole IR control function system.

Further, there is a need for a universal system such that the unit can work with different video cameras. In addition, this device has to be low cost, portable, easy to operate, light weight and rugged.

The present invention provides such a video camera remote controlling system.

### CROSS REFERENCE TO RELATED APPLICATIONS

Field of Search

| Intern'l Class: | G02B 17/00; H04B Q1/00; H04B007/24; H04L 7/24 |
|---|---|
| US Class | 367/117; 335/002, 004, 185; 359/109, 142, 152, 154, |
| | 180, 189; 388/825 |

### U.S. Patent Documents

| | | | |
|---|---|---|---|
| 4655567 | Apr. 7, 1987 | Morley | 352/243 |

This patent is of old technology. Wireless remote controlling electronics are expensive at that time and not readily available; and the invention has nothing to do with the wireless technology.

| | | | |
|---|---|---|---|
| 5073824 | Jun. 15, 1990 | Vertin | 348/211 |

This invention is a very costly remote control and camera combination. It is not a stand-alone portable camera mounting device for generic video camera.

| | | | |
|---|---|---|---|
| 5111288 | Oct. 8, 1991 | Blackshear | 348/143 |

This invention is not wirelessly remote control.

| | | | |
|---|---|---|---|
| 5179421 | Jan. 12, 1993 | Parker | 356/139 |

This invention is using infrared (IR) as a measuring means for position calculation.

| | | | |
|---|---|---|---|
| 5181120 | Jan. 19, 1993 | Hickey | 348/373 |

This invention is not wirelessly remote control.

| | | | |
|---|---|---|---|
| 5436542 | Jul. 25, 1995 | Petelin | 318/567 |

This invention is for telescopic cameras for surgery.

| | | | |
|---|---|---|---|
| 5568205 | Oct. 22, 1996 | Hurwitz | 348/732 |

This is an invention on wireless audio/video transmitter system,

### SUMMARY OF THE INVENTION

A remote control system for controlling generic handheld IR remote controller of handheld video cameras and the switches on the body of the video cameras. This remote control system has both conventional remote control device and wireless remote control device. It includes a main system with a remote device controller, a wireless remote device controller and a rain shield to protect the main system and the video camera. The remote device controller includes electronic components receives input signals from user, and transmits the signals to the PCBA of the main unit via the harness cable. The main unit of the main system is equipped with PCBA, of which a portion of the electronic components and the firmware program will then generate electrical functions to drive the designated mechanism.

The wireless remote device controller includes electronic components and program, which receives input signals from user, generates radio frequency signal functions and transmits the signal functions to the main system wirelessly.

The main unit includes mechanical hardware to provide actuating functions to actuate the generic handheld video camera controller and the different switches on the camera body.

A portion of the PCBA of the main unit includes electronic components and firmware program, which detects and receives signal functions from the wireless remote device controller wirelessly; and then provides electrical driving functions to control the mechanical hardware to carryout the actuating functions of the main system.

A light tunnel, which provides a path for the IR signal generated by the remote controller, to the IR receiver of the video camera.

A transparent shield covers the main system and the video camera, and protects them from rain and minimizes the dust contamination to the optical lens.

Mounting holes are provided at the bottom of the base plate subassembly for operational installation.

This device supports generic handheld video camera. In practice it gives the best results especially with the ones with remote controller, which can control most of the critical functions of the video camera. This device converts a low cost personal handheld video camera into a reasonably sophisticated surveillance video camera with color picture, high resolution, high zoom quality, stereo audio and digital video output.

Other features and advantages of the invention will appear from the following description in which the preferred embodiments have been set forth in detail, in conjunction with the accompanying drawings.

### BRIEF DESCRIPTION OF THE DRAWINGS

FIG. 1 is the front plan view of the remote-control system for generic handheld video camera, which includes a wireless remote device controller, a main system which consists of a main unit; a remote controller connected to the main unit by a harness cable; a slider switch actuating system, which is connected to the main unit by a harness cable; a push button switch actuating system, which is connected to the main unit by a harness cable; and a base plate assembly supporting all the components and the generic video camera. In addition, an adjustable IR (infrared) signal transmission tunnel, which provides direct optical path from the main unit to the IR receiver inlet lens of the video camera.

The adjustable IR tunnel consists of a first tunnel section, a rotary union and an adjustable length tunnel. The whole system is covered by a transparent shield, according to present invention.

In addition, a generic handheld video camera is mounted to the device to demonstrate the relative usage of the device.

FIG. 2 is the section view along 1-1 of the main unit of the main system assembly depicting a portion of the main PCBA, a portion of the mounting block with actuating solenoid subassemblies mounted to it, a portion of the video camera handheld controller, a portion of the bottom housing, a portion of the IR light tunnel with the light source and light vectors according to the present invention.

FIG. 3 is the cross section view of the main system taken along the line 2-2 of FIG. 2. It depicts a portion of the bottom housing, a portion of the top cover, a portion of the generic video camera handheld controller with the IR light source, a portion of the mounting block, a portion of the PCBA, a portion of the actuating solenoid subassemblies with wire hardness connected to the PCBA and a portion of the bottom cover according to the present invention.

FIG. 4 is the top plan view of a generic video camera handheld controller. It depicts the push button switches for controlling different functions of the video camera and the IR light source of the controller.

FIG. 5 is the section view of FIG. 1 taken along 3-3 showing the IR light passage inside the light tunnel. It depicts a portion of the video camera handheld controller with the light source, a portion of the first section light tunnel with a 90 degree reflection mirror, a portion of the rotary union of the light tunnel with a 90 degree reflection mirror, a portion of the adjustable length section of the light tunnel with a 90 degree reflection mirror, a portion of the cover lens at the end of the light tunnel and the IR inlet lens of the video camera according to present invention.

### DETAILED DESCRIPTION OF THE PREFERRED EMBODIMENT

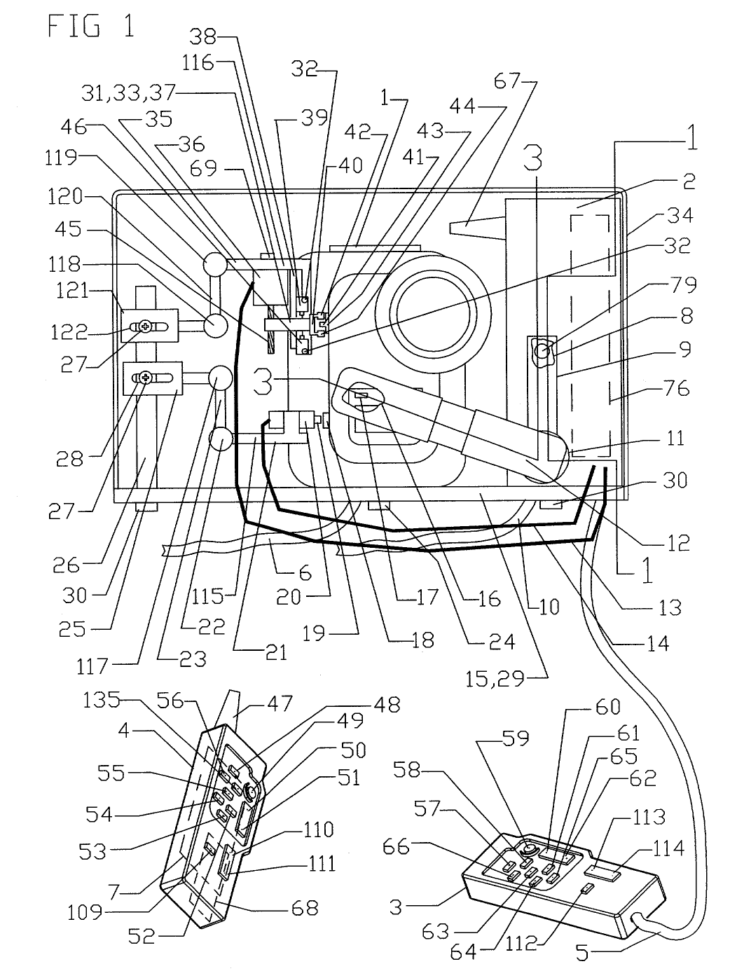

FIG. 1 is the front view of the overall system of the remote-control system for generic handheld video camera, which includes a wireless remote device controller 4, a main unit 2, which is connected to a remote controller 3 by the harness cable 5, a push-button switch actuator subassembly 21, a slider switch actuator subassembly 35, a base subassembly 15 and a shield 34, according to the present invention. As seen in the figure, a generic handheld video camera 1 is mounted inside the device to demonstrate the relative function of the device.

The generic video camera 1 is mounted to the base assembly 15 by the screw 24 into the generic threaded hole at the bottom of the video camera 1. Push-button switch 18 is part of video camera 1 for user to control certain function of the video camera 1. Slider switch 43 is part of video camera 1 for user to control certain function of the video camera 1. Switch handle 41 is protruded part of the slider switch 43 for user to control the switch 43 with fingertips to set the switch to up position or down position.

The push-button switch actuator subassembly 21 consists of a spring return solenoid 20, which is connected to the PCBA 76 of the main unit 2 by the harness cable 14, is mounted to the arm 115. Arm 115 is attached to a rotary joint 22, which is joined to second rotary joint 117 by the middle arm 23. The second rotary joint 117 is attached to the mounting arm 25, which is assembled to the vertical mounting base 26 by at least one fastener 27 through the slot opening 28 of the mounting arm 25. The rotary joint 22 allows the angle between the arm 115 and the middle arm 23 to be adjustable and then fixed after it is set to the desirable angle. The rotary joint 117 allows the angle between the middle arm 117 and the mounting arm 25 to be adjustable and then fixed after it is set to the desirable angle. The combination of the slot opening 28, the rotary joint 22 and the rotary joint 117 provides an adjustable mechanical linkage to compensate any difference in the location of the push button switch 18 between different generic video cameras. It allows the solenoid 20 to be setup that it is always perpendicular to the switch 18; and the plunger 19 will actuate the switch 18 precisely whenever the solenoid 20 is energized.

The slider switch actuator subassembly 35 consists of a linear motion arm 37, which has a guide hole 31 and an internal threaded hole 33. The guide shaft 38, which OD is slightly smaller than the ID of the guide hole 31, is supported by the arm 116. The guide hole 31 of the linear motion arm 37 goes over the guide shaft 38 and travel linearly relative to the guide shaft 38.

The internal threaded hole 33 mates over the threaded shaft portion 45 of the electrical motor 36, which can be a AC motor, DC motor, servo motor or stepper motor. As the electrical motor 36 rotates clockwise and counterclockwise, the threaded shaft 45 functions as a lead screw and drives the linear motion arm 37 linearly forward and backward along the guide shaft 38. The electrical motor 36 is supported by the arm 116 by at least one fastener 69, which can be screw, rivet or other mounting mechanisms to facilitate the assembly. This electrical motor 36 is connected to the PCBA 76 of the main unit 2 by the harness cable 13.

The upper limit switch 39 is mounted to the arm 35 by at least one fastener 32, which can be screw, rivet or other mounting mechanisms to facilitate the assembly. As the linear motion arm 37 travels upward, it will actuate the upper limit switch 39, which is electrically connected to the PCBA 76 of the main unit 2. The PCBA 76 is programmed to stop the electrical motor 36 to drive the linear motion arm 37 to go upward any further as it senses the actuated signal from the upper limit switch 39.

The lower limit switch 46 is mounted to the arm 35 by at least one fastener 32, which can be screw, rivet or other mounting mechanisms to facilitate the assembly. As the linear motion arm 37 travels downward, it will actuate the lower limit switch 46, which is electrically connected to the PCBA 76 of the main unit 2. The PCBA 76 is programmed to stop the electrical motor 36 to drive the linear motion arm 37 to go downward any further as it senses the actuated signal from the lower limit switch 46.

The switch actuator hand 40, which is attached to the linear motion arm 37, is made of elastic material such as rubber and silicon rubber. The upper finger 42, which is protruded from the switch actuator hand 40, is extended to surround the top of the switch handle 41 of the slider switch 43 of the video camera 1. As the electrical motor 36 drives the linear motion arm 37 downward, the upper finger 42 will push the switch handle 41 downward until the slider switch 43 is set at down position. The lower finger 44, which is protruded from the switch actuator hand 40, is extended to surround the bottom of the switch handle 41 of the slider switch 43 of the video camera 1. As the electrical motor 36 drives the linear motion arm 37 upward, the lower finger 44 will push the switch handle 41 upward until the slider switch 43 is set at up position. The elastic material properties of the actuator hand 40, upper finger 42 and lower finger 44 simulate human fingertips to minimize slippage during operation and prevent the switch handle to be damaged.

Arm 37 is attached to a rotary joint 119, which is joined to second rotary joint 118 by the middle arm 120. The second rotary joint 118 is attached to the mounting arm 121, which is assembled to the vertical mounting base 26 by at least one fastener 27 through the slot opening 122 of the mounting arm 121. The rotary joint 119 allows the angle between the arm 37 and the middle arm 120 to be adjustable and then fixed after it is set to the desirable angle. The rotary joint 118 allows the angle between the middle arm 120 and the mounting arm 121 to be adjustable and then fixed after it is set to the desirable angle. The combination of the slot opening 122, the rotary joint 119 and the rotary joint 118 provides an adjustable mechanical linkage to compensate most of the difference in the location of the slider switch 43 between different generic video cameras. It allows the linear motion arm 37 to be setup that it is always perpendicular to the slider switch 43; and both the upper finger 42 and lower finger 44 are aligned to the switch handle 41.

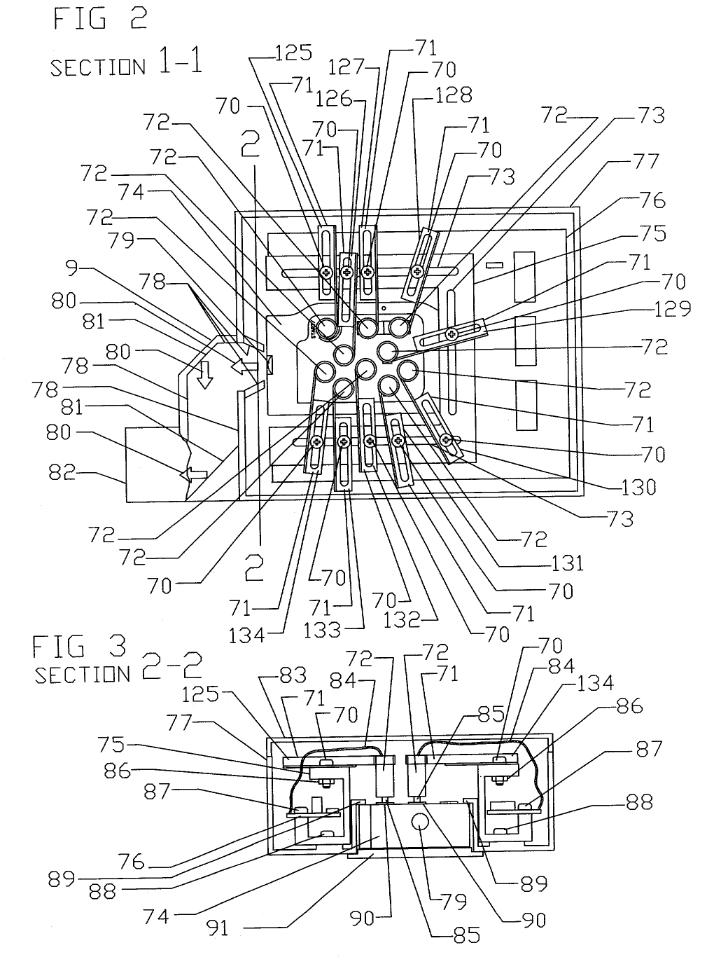

The main unit 2 is mounted to the base assembly 15 by at least one fastener 30, which can be screw, rivet or other mounting mechanisms to facilitate the assembly. Further details are shown in FIG. 2, FIG. 3 and FIG. 5. The starting section of IR transmission tunnel 9, which covers the IR source 79, is attached to the main unit 2. The cutout 8 of the tunnel 9 exposes the relative position of the IR source 79 in the system. The other end of the IR transmission tunnel 9 is attached to one end of the IR transmission rotary union 11. The other end of the IR transmission rotary union 11 is attached to the inlet end of the adjustable length IR transmission tunnel 12. The outlet end of the adjustable length IR transmission tunnel 12 is aligned to cover the IR receiver inlet lens 17 of the video camera 1. The cutout 16 of the adjustable length IR transmission tunnel 12 exposes the relative position of the IR receiver inlet lens 17 in the system. All the internal walls of the IR transmission tunnel 9, the IR transmission rotary union 11 and the adjustable length IR transmission tunnel 12 are made with reflective surfaces and 90 degree reflection mirror to form a light transmission tunnel for the IR to travel from the IR source 79 of the main unit 2 to the IR receiver inlet lens 17 of the video camera 1. There will be more explanation in FIG. 2 and FIG. 5. The IR transmission rotary union 11 allows the angle between the IR transmission tunnel 9 and the adjustable length IR transmission tunnel 12 to be adjustable and then fixed after it is set to the desirable angle. The combination of the adjustable angle of the IR transmission rotary union 11 and the adjustable length IR transmission tunnel 12 provides an adjustable mechanical linkage to compensate most of the difference in the location of the IR receiver inlet lens 17 between different generic video cameras. It allows the outlet end of the adjustable length IR transmission tunnel 12 to be setup that it always ends with covering the IR receiver inlet lens 17.

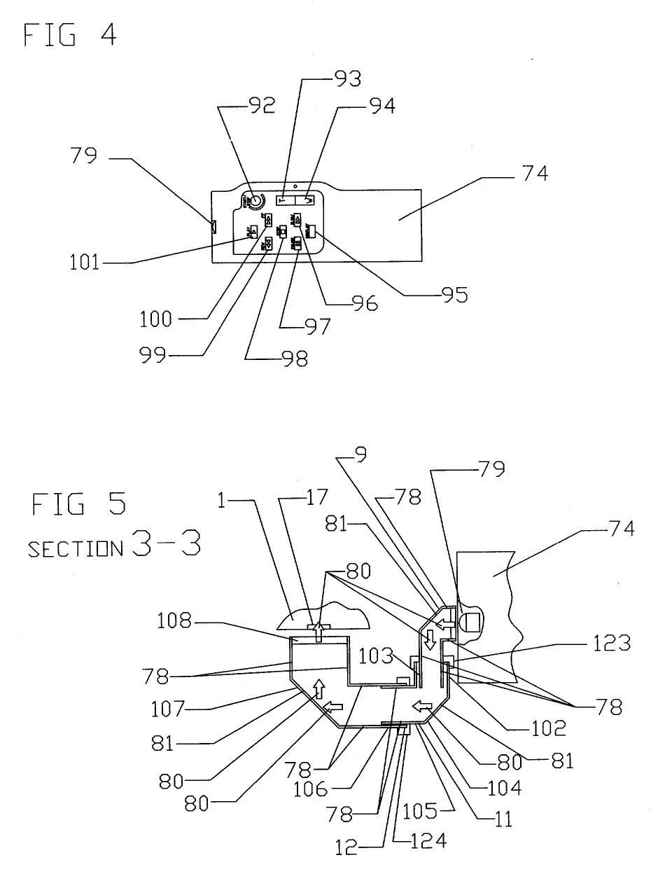

The remote controller 3 is connected to the main unit 2 via the harness cable 5. All the switches 57, 58, 59, 60, 61, 62, 63, 64, 65, 66, 112, 113 and 114 are electrically connected to the PCBA 76 of the main unit through the harness cable 5. All these switches correlated to different functions of the video camera 1. As any one of these switches is activated, electrical signals will be sent to the PCBA 76, which in turn will send the correlated signals to the video camera 1 either by the IR source 79, push-button actuator subassembly 21 or by the slider switch actuator subassembly 35. There are more detail explanation in FIG. 2, FIG. 3 and FIG. 4.

The wireless remote controller 4 includes switches 48, 49, 50, 51, 52, 53, 54, 55, 56, 109, 110, 111 and 135, which are connected to PCBA 7. PCBA 7, which consists of electronic components, programmable components and programs, will detect input signals from the above switches; then generates corresponding radio frequency signals 68 and emits the radio frequency signals 68 out by the antenna 47. This wireless remote controller 4 can be battery powered, DC powered or AC powered. The PCBA 76 of the main unit 2, which also has electronic components, programmable components and programs for detecting radio frequency signals will detect the radio frequency signals 68 via the antenna 67; then generates corresponding electrical functions to send the correlated signals to the video camera 1 either by the IR source 79, push-button actuator subassembly 21 or by the slider switch actuator subassembly 35. There are more detail explanation in FIG. 2, FIG. 3 and FIG. 4.

In practice, the switches of the remote controller 3 and wireless remote controller 4 for controlling the push-button switch actuator subassembly 21 and the slider switch actuator subassembly 35 are pre-defined and correlated together as follow:

The switch 112 and switch 109 are used to control the push-button switch actuator subassembly 21. The switch 113 and switch 110 are used to control the upward motion of the slider switch actuator subassembly 35 and the switch 114 and switch 111 are used to control the downward motion of the slider switch actuator subassembly 35. In the Figure only one set of push-button switch actuator subassembly 21 and one set of slider switch actuator subassembly 35 are shown. However, in practice, it is user's choice to determine the quantity of sets of these switches, push-button switch actuator subassembly 21 and slider switch actuator subassembly 35 to be used to facilitate full control of the video camera 1.

In operation, an electrical signal is sent to the PCBA 76 of the main unit 2 through the harness cable 5 when switch 112 of the remote controller 3 receives the input from the user. The PCBA 76 will convert the signal to an electrical function to activate the solenoid 20 of the push-button switch actuator subassembly 21. The plunger 19 of the solenoid 20 will extend out and push against and activate the push-button switch 18 of the video camera 1. Then, the video camera 1 will eventually carry out the function as per the switch 18 of the video camera 1 should suppose to perform. This design allows the switch 112 of the remote controller 3 to control the push-button switch 18 of the video camera 1 from a distance away and it is not directional dependence.

As for wireless remote operation, a radio frequency signal 68 is generated by the wireless remote controller 4 when switch 109 is activated by the user. This radio frequency signal 68 is then emitted out through the antenna 47. The PCBA 76 of the main unit 2 will detect and receive this radio frequency signal 68 via the antenna 67 and generate corresponding electrical functions to activate the solenoid 20 of the push-button switch actuator subassembly 21. The plunger 19 of the solenoid 20 will extend out and push against and activate the switch 18 of the video camera 1. The video camera 1 will eventually carry out the function as per the switch 18 of the video camera 1 should suppose to perform. This design allows the switch 109 of the wireless remote controller 4 to control the push-button switch 18 of the video camera 1 from a distance away and it is not directional dependence.

An electrical signal is sent to the PCBA 76 of the main unit 2 through the harness cable 5 when switch 113 of the remote controller 3 receives the input from the user. The PCBA 76 will convert the signal to an electrical function to rotate the electrical motor 36 of the slider switch actuator subassembly 35 such that the linear motion arm will move upward. As a result the lower finger 44 will move upward and push the slider switch handle 41 of the slider switch 43 to the up position. Then, the video camera 1 will eventually carry out the function as per the up position of the switch 43 of the video camera 1 should suppose to perform. Another electrical signal is sent to the PCBA 76 of the main unit 2 through the harness cable 5 when switch 114 of the remote controller 3 receives the input from the user. The PCBA 76 will convert the signal to an electrical function to rotate the electrical motor 36 of the slider switch actuator subassembly 35 such that the linear motion arm will move downward. As a result the upper finger 42 will move downward and push the slider switch handle 41 of the slider switch 43 to the down position. Then, the video camera 1 will eventually carry out the function as per the down position of the switch 43 of the video camera 1 should suppose to perform. This design allows the switch 113 and switch 114 of the remote controller 3 to control the slider switch 43 of the video camera 1 from a distance away and it is not directional dependence.

As for wireless remote operation, a radio frequency signal 68 is generated by the wireless remote controller 4 when switch 110 is activated by the user. This radio frequency signal 68 is then emitted out through the antenna 47. The PCBA 76 of the main unit 2 will detect and receive this radio frequency signal 68 via the antenna 67 and generate corresponding electrical functions to rotate the electrical motor 36 of the slider switch actuator subassembly 35 such that the linear motion arm will move upward. As a result the lower finger 44 will move upward and push the slider switch handle 41 of the slider switch 43 to the up position. Then, the video camera 1 will eventually carry out the function as per the up position of the switch 43 of the video camera 1 should suppose to perform. Another radio frequency signal 68 is generated by the wireless remote controller 4 when switch 111 is activated by the user. This radio frequency signal 68 is then emitted out through the antenna 47. The PCBA 76 of the main unit 2 will detect and receive this radio frequency signal 68 via the antenna 67 and generate corresponding electrical functions to rotate the electrical motor 36 of the slider switch actuator subassembly 35 such that the linear motion arm will move downward. As a result the upper finger 42 will move downward and push the slider switch handle 41 of the slider switch 43 to the down position. Then, the video camera 1 will eventually carry out the function as per the down position of the switch 43 of the video camera 1 should suppose to perform. This design allows the switch 110 and switch 111 of the wireless remote controller 4 to control the slider switch 43 of the video camera 1 from a distance away and it is not directional dependence.

The video and audio signal cable 6 is direct output signal from the video camera 1. The video camera receives power input from its own manufacturer-suggested method, which may be DC, AC or battery powered. The power supply cable 10 provides electrical power to the main unit. The main unit can have AC or DC power input.

FIG. 2 is the cross section view of FIG. 1 taken along 1-1. It illustrates the principal components and alignment inside the main unit 2. The main unit 2 includes the base housing 77, which can be made of metal or plastic provides the mounting base and framework for the main unit 2. The handheld video camera controller 74 is installed to the base housing 77. The mounting block 75 is supported by the base housing 77 and the PCBA 76 is supported by the mounting block 75. Further details are illustrated in FIG. 3.

The solenoid-bracket subassembly 125, which includes a spring return solenoid 72 is attached to the slotted bracket 71, which is fastened to the mounting block 75 through the slot opening 73. The plunger 85 (illustrated in FIG. 3) is aligned to the switch 90 of the handheld video camera controller 74. There are ten identical solenoid and bracket subassembly subassemblies namely 125, 126, 127, 128, 129, 130, 131, 132, 133 and 134 shown in the FIG. 2 and the actual quantity depends on the user requirement.

One set of the above solenoid-bracket subassembly is used to set on top of each push-button switch of the handheld video camera controller 74. The combination of the slotted bracket 71 and the slot opening 73 provides adequate assembly freedom for a good number of sets of said solenoid-bracket subassembly 125 to be able to pack together and align to cover all the push-button switches of the handheld video camera controller 74.

The switches of the remote controller 3 are correlated to the switches of the wireless controller 4 and they are all correlated to the solenoid-bracket subassemblies as in the following tables

Switch 59 correlated to Switch 49 and Solenoid-Bracket Subassembly 125.

Switch 60 correlated to Switch 50 and Solenoid-Bracket Subassembly 127.

Switch 62 correlated to Switch 51 and Solenoid-Bracket Subassembly 128.

Switch 57 correlated to Switch 48 and Solenoid-Bracket Subassembly 134.

Switch 66 correlated to Switch 56 and Solenoid-Bracket Subassembly 133.

Switch 58 correlated to Switch 135 and Solenoid-Bracket Subassembly 126.

Switch 63 correlated to Switch 55 and Solenoid-Bracket Subassembly 132.

Switch 64 correlated to Switch 54 and Solenoid-Bracket Subassembly 131.

Switch 61 correlated to Switch 52 and Solenoid-Bracket Subassembly 129.

Switch 65 correlated to Switch 53 and Solenoid-Bracket Subassembly 130.

The present invention functions with both controllers together, the remote controller 3 and the wireless remote controller 4, or either one of the controllers alone.

The IR source 79 of the handheld video camera controller 74 is aligned to the inlet of the IR transmission tunnel 9, which has reflective surfaces 78 along the side of the internal walls and 90 degree reflection mirrors 81 to direct the light vectors 80 wherever a 90 degree turns of the light vectors 80 is required. The reflective surfaces 78 minimize the mount of quality lost of the light vectors 80 during the transmission processes.

FIG. 3 is the cross section view of FIG. 2 taken along 2-2. It illustrates the actuating function of the solenoid-bracket subassembly 125 working on the push-button switch 90 of the handheld video camera controller 74. The solenoid 72, which is connected to the PCBA 76 by the conductor wire 84 is a spring return solenoid. The plunger 85 is retracted inside the solenoid 72 when it is not energized. When current is connected to the solenoid 72, the plunger 85 is driven by the electromagnetic force to push against the push-button switch 90 and the handheld video camera controller 74 will emit IR signals through the IR source 79. The plunger 85 will retract back into the solenoid 72 as soon as the current is disconnected and the push-button switch 90 is released.

Each bracket 71 is secured to the mounting block 75 by at least one fastener 70, which can be screw, rivet, nut and bolt or any other mechanical device which can facilitate the assembly. The PCBA 76 is supported by the mounting block 75 and is secured to the mounting block 75 by at least one fastener 87, which can be screw, rivet, nut and bolt or any other mechanical device which can facilitate the assembly. The handheld video camera controller 74 is confined in place by the protrusion 89 surrounding the top edges of the handheld video camera controller 74 while exposing the switches to the solenoid 72. The back of the handheld video camera controller 74 is secured by the bottom cover 91 of the main unit 2. The mounting block 75 is supported by the bottom housing 77 and is secured to the bottom housing 77 by at least one fastener 88, which can be screw, rivet, nut and bolt or any other mechanical device which can facilitate the assembly. The top cover 83 covers the top portion of the main unit 2 and mate to the edges of the bottom housing 77.

FIG. 4 is the top plan view of the handheld video camera controller 74. The IR light source 79 emits IR signals generated by the generic handheld video camera controller 74. Switch 92 controls the recording start and stop functions. Switch 93 controls the zoom in function. Switch 94 controls the zoom out function. Switch 101 controls the play function. Switch 100 controls the fast forward function. Switch 99 controls the fast rewind function. Switch 98 controls the stop function. Switch 97 controls the pause function. Switch 96 controls the slow play function. Switch 95 controls the display function. The IR source 79 will emit the correlated IR signals, as any one of the above switches is activate.

FIG. 5 is the cross section view of FIG. 1 taken along 3-3. It illustrates the IR light transmission path. The IR signals are generated by the IR light source 79 of the handheld video camera controller 74. The IR signals are emitted into the IR transmission tunnel 9 as light vector 80. It is then diverted to a 90 degrees turn by the 90 degrees reflection mirror 81 and enters into the inlet stator section 103 of the IR transmission rotary union 11. The rotary section 102 of the IR transmission rotary union 11 can rotate relatively to the inlet stator section 103. After the desirable angle between the rotary section 102 and the inlet stator section 103 of the IR transmission rotary union 11 is set, the angle will be fixed by fastener 123, which can be screw, rivet, nut and bolt, clamping device or any other mechanical device which can facilitate the assembly. The light vector 80 will then be diverted to a 90 degrees turn by the 90 degrees reflection mirror 81 of the 90 degrees reflection section 104 of the IR transmission rotary union 11 and enters into the inlet stator section 105 of the adjustable length IR transmission tunnel 12. The extension section 106 of the adjustable length IR transmission tunnel 12 can extend relatively to the inlet stator section 105. After the desirable length between the inlet stator section 105 and the extension section 106 of the adjustable length IR transmission tunnel 12 is set, the length will be fixed by fastener 124, which can be screw, rivet, nut and bolt, clamping device or any other mechanical device which can facilitate the assembly. The light vector 80 will then be diverted to a 90 degrees turn by the 90 degrees reflection mirror 81 of the 90 degrees reflection section 107 of the adjustable length IR transmission tunnel 12. The tunnel end cover lens 108, which is made of transparent material like polycarbonate or glass, protects the light transmission channel from dust and foreign contamination. The light vector 80 passes through the lens 108 and enters into the generic video camera 1 through the IR receiver inlet lens 17. All the internal walls of the IR light transmission channel are light reflective surfaces 78. These reflective surfaces 78 minimize the mount of quality lost of the light vectors 80 during the transmission processes.

In practice the user adjusts the angle between the rotary section 102 and the inlet stator section 103 of the IR transmission rotary union 11; and the length between the inlet stator section 105 and the extension section 106 of the adjustable length IR transmission tunnel 12 to align the lens 108 to cover over the IR receiver inlet lens 17. In results, the IR signals can be transmitted from the light source 79 to the IR receiver inlet lens 17.

In operation, the user first has to install the handheld video camera controller 74 into the main unit 2, then align and correlate the solenoid-bracket subassemblies 125 etc of the main unit 2 to the switches 92 etc of the handheld video camera controller 74 as following table

Switch 92 correlated to Solenoid-Bracket Subassembly 125.

Switch 93 correlated to Solenoid-Bracket Subassembly 127.

Switch 94 correlated to Solenoid-Bracket Subassembly 128.

Switch 101 correlated to Solenoid-Bracket Subassembly 134.

Switch 99 correlated to Solenoid-Bracket Subassembly 133.

Switch 100 correlated to Solenoid-Bracket Subassembly 126.

Switch 98 correlated to Solenoid-Bracket Subassembly 132.

Switch 97 correlated to Solenoid-Bracket Subassembly 131.

Switch 96 correlated to Solenoid-Bracket Subassembly 129.

Switch 95 correlated to Solenoid-Bracket Subassembly 130.

All the solenoid-bracket subassemblies are identical and it is user's choice to chose anyone of these subassemblies to correlate to anyone of the switches of the handheld video camera controller.

In operation, an electrical signal is sent to the PCBA 76 of the main unit 2 through the harness cable 5 when switch 60 of the remote controller 3 receives the input from the user. The PCBA 76 will convert the signal to an electrical function to activate the solenoid 72 of the solenoid-bracket subassembly 127. The plunger 85 of the above solenoid will extend out and push against and activate the switch 93 of the handheld video camera controller 74. Then the handheld video camera controller 74 will issue an IR signal, which has the same quality as the light vector 80 and is named as light vector 80 in this document. This light vector 80 is then emitted out by the IR source 79. This light vector 80 will then travel through the light tunnel as per FIG. 5 to IR inlet lens 17 of the video camera 1 and eventually the video camera 1 will carry out the function as per the switch 93 of the handheld video camera controller 74, which is already set to correlate to switch 60 during the setup process. By the same token, all the switches of the remote controller 3 can perform the similar controlling function of the switches of the handheld video camera controller 74 from a distance away and it is not directional dependence.

As for wireless remote operation, a radio frequency signal 68 is generated by the wireless remote controller 4 when switch 50 is activated by the user. This radio frequency signal 68 is then emitted out through the antenna 47. The PCBA76 of the main unit 2 will detect and receive this radio frequency signal 68 via the antenna 67 and generate corresponding electrical functions to activate the solenoid 72 of the solenoid-bracket subassembly 127. The plunger 85 of the above solenoid will extend out and push against and activate the switch 93 of the handheld video camera controller 74. Then the handheld video camera controller 74 will issue an IR signal, which has the same quality as the light vector 80 and is named as light vector 80 in this document. This light vector 80 is then emitted out by the IR source 79. This light vector 80 will then travel through the light tunnel as per FIG. 5 to IR inlet lens 17 of the video camera 1 and eventually the video camera 1 will carry out the function as per the switch 93 of the handheld video camera controller 74, which is already set to correlate to switch 50 during the setup process. By the same token, all the switches of the wireless remote controller 4 can perform the similar controlling function of the switches of the handheld video camera controller 74 from a distance away and it is not directional dependence.

It will be appreciated that the sizes and shapes and dispositions of various main unit, push-button switch actuator subassembly, slider switch actuator subassembly, shield, remote controller, wireless remote controller and handheld device controller can be varied, without departing from the spirit and scope of the invention. Similarly, the size and location of mounting holes, housing, material protrusions and the like may be varied. While the sealing of the internal housing spaces with gaskets, seal or other sealing mechanisms may instead be used. While the remote control device has been described with respect to application with handheld video cameras, the described system may be applied to other video cameras, including without limitation to supply mounting for digital cameras, cameras and other IR (infrared) handheld control device.

Modifications and variations may be made to the disclosed embodiments without departing from the subject and spirit of the invention as defined by the following claims.

What is claimed is:

1. A remote control device for controlling the functions of a video camera without directional limitation by means of controlling the switches on the video camera body and the remote controller of the said video camera. This system comprises:
Without directional limitation is defined as the remote controller, which includes wired remote controller and wireless remote controller, does not have to be pointing at the receiver unit without visual blockage, which is defined as the light travel, directly or reflectively, path is blocked between the light emitting point and the detecting point.
A base subassembly as the stationary support of said device.
A main unit, supported by the base subassembly, provides housing and mounting for principal components, mounting for video camera controller, and carry out the electromechanical control functions to control the video camera IR (infrared) controller.
Solenoid-bracket subassemblies, supported by the main unit and connected to the PCBA, provide mechanical means to actuate the switches of the video camera controller.
Push-button switch actuator subassemblies, which are supported by base subassembly and connected to the PCBA of the main unit, is used for actuating push-button switch on the video camera.
Slider switch actuator subassemblies, which are supported by base subassembly and connected to the PCBA of the main unit, is used for actuating slider switch on the video camera.
A remote controller, connected to the PCBA of the main unit by a harness cable, is to receive input form the user.
A wireless remote controller apparatus is equipped with electronic components, programs and electrical switches to receive user input; and then generates wireless radio frequency signals and then emits the said signals out through antenna.
A PCBA, which is supported by the main unit and being the control system of the main unit, is equipped with radio frequency signal receiver, electronic components, programs to receive the said radio frequency signals through antenna and generates electronic functions to drive the push-button switch actuator subassembly, slider switch actuator subassembly and the solenoid-bracket subassembly of the main unit. The said PCBA can also receive signals from the remote controller and then generates electronic functions to drive the push-button switch actuator subassembly, slider switch actuator subassembly and the solenoid-bracket subassembly of the main unit.
A light tunnel, which can be fixed or adjustable, supported by the main unit, provides light transmission means for the IR signals to travel from the light source of the video camera controller to the IR inlet lens of the video camera.
A transparent shield subassembly, which is supported by the said base subassembly provides rain protection to video camera and all the critical components of the system, and allows the video camera to perform the video capturing functions in the rain.
An internal-threaded hole and a guide hole are provided in the center area of the bottom of the base subassembly to accommodate the generic mounting means of generic tripod and generic camera mounting devices.
At least one mounting hole is provided at the bottom of the base subassembly
IR signal is infrared signal
PCBA is printed circuit board assembly

2 The apparatus of claim 1, wherein said using push-button switch actuator subassembly to actuate a push-button switch is the method of utilizing electromechanical means to turn on and off a push-button switch on the video camera.

3 The apparatus of claim 2, wherein said the method of using a remote controller, which is connected to the PCBA, to control the said push-button switch actuator subassembly to actuate a push-button switch on the video camera.

4 The apparatus of claim 2, wherein said the method of using a wireless remote controller, which emits wireless radio frequency signal to a PCBA with radio frequency signal receiver components to control the said push-button switch actuator subassembly to actuate a push-button switch on the video camera.

5 The apparatus of claim 1, wherein said push-button switch actuator subassembly includes
A spring return solenoid, which is connected to the PCBA,
A support arm provides support to the said solenoid,
A first rotary joint with one end connected to the said support arm and the other end connected to the middle arm,
A second rotary joint with one end connected to the said middle arm and the other end connected to a mounting arm with a slotted opening for mounting,
A rotary joint is defined as a mechanical device, which has two mechanical ends for foreign object to fasten to. The angle between these said mechanical ends is adjustable and can be set permanently by fastener, which can be screw, rivet, clamping device or other assembly mechanisms to facilitate the permanently setting function.

6 The apparatus of claim 5, wherein said the combination of the said support arm, first rotary joint, the middle arm, the second rotary joint and the mounting arm with a slotted opening for mounting provides an universal means to accommodate different push-button switch locations on the video cameras such that the said solenoid can always be aligned perpendicular to the said push-button switch.

7 The apparatus of claim 5, wherein said the said solenoid is aligned with the center axis of the solenoid perpendicular to the center of the push-button switch on the video camera.

8 The apparatus of claim 7, wherein said the plunger of the said solenoid extends out when electrical current is supplied to the solenoid.

9 The apparatus of claim 8, wherein said the said plunger will push against and actuate the push-button switch on the video camera.

10 The apparatus of claim 1, wherein said using slider switch actuator subassembly to actuate a slider switch is the method of utilizing electromechanical means to switch a slider switch to up and down position of a slider switch on the video camera.

11 The apparatus of claim 10, wherein said the said method also applies to horizontally mounted slider switch actuator subassembly of utilizing electromechanical means to switch a slider switch to backward and forward positions, and left and right position of slider switches on the video camera.

12 The apparatus of claim 10, wherein said the method of using a remote controller, which is connected to the PCBA, to control the said slider switch actuator subassembly to actuate a slider switch on the video camera.

13 The apparatus of claim 10, wherein said the method of using a wireless remote controller, which emits wireless radio frequency signal to a PCBA with radio frequency signal receiver components to control the said slider switch actuator subassembly to actuate a slider switch on the video camera.

14 The apparatus of claim 1, wherein said slider switch actuator subassembly includes
An electrical motor, which is connected to the PCBA, has a lead screw shaft,
A support arm provides support to the said motor,
A guide shaft supported by the said support arm,
An upper limit switch supported by the said support arm,
A lower limit switch supported by the said support arm,
A linear motion arm with an internal-threaded hole which mates to the external threads of the lead screw shaft of the said electrical motor and a guide hole, with axis parallel to the axis of the said internal-threaded hole, which is machined through the said linear motion arm with diameter slightly larger than the said guide shaft diameter, slips over the said guide shaft.
A switch actuation hand, which is supported by the linear motion arm, has one protrusion finger wrap over the top of the handle of the slider switch on the video camera and one protrusion finger wrap over the bottom of the handle of the said slider switch,
A first rotary joint with one end connected to the said support arm and the other end connected to the middle arm,
A second rotary joint with one end connected to the said middle arm and the other end connected to a mounting arm with a slotted opening for mounting,
A rotary joint is defined as a mechanical device, which has two mechanical ends for foreign object to fasten to. The angle between these said mechanical ends is adjustable and can be set permanently by fastener which can be screw, rivet, clamping device or other assembly mechanisms to facilitate the permanently setting function.

15 The apparatus of claim 14, wherein said the said upper limit switch, which defines the upward travel limit of the linear motion arm, upon actuation this said upper limit switch will send a signal to the PCBA, which will stop the said electrical motor and prevent the said electrical motor to drive the linear motion arm further upward.

16 The apparatus of claim 14, wherein said the said lower limit switch, which defines the downward travel limit of the linear motion arm, upon actuation this said lower limit switch will send a signal to the PCBA, which will stop the said electrical motor and prevent the said electrical motor to drive the linear motion arm further downward.

17 The apparatus of claim 14, wherein said the said electrical motor can be AC motor, DC motor, servo motor and stepper motor.

18 The apparatus of claim 14, wherein said the said top finger is aligned to the top of the switch handle of the slider switch of the video camera such that when the said electrical motor drives the linear motion arm to go downward the said top finger will push against the switch handle and eventually switches the slider switch to the down position before the linear motion arm activates the said lower limit switch.

19 The apparatus of claim 14, wherein said the said bottom finger is aligned to the bottom of the switch handle of the slider switch of the video camera such that when the said electrical motor drives the linear motion arm to go upward the said top finger will push against the switch handle and eventually switches the slider switch to the up position before the linear motion arm activates the said upper limit switch.

20 The apparatus of claim 14, wherein said the combination of the said support arm, first rotary joint, the middle arm, the second rotary joint and the mounting arm with a slotted opening for mounting provides an universal means to accommodate different slider switch locations on video cameras such that the said top finger and bottom finger can always be aligned to push the switch handle of the said slider switch to the up position and down position.

21 The apparatus of claim 1, wherein said the said base subassembly provide mounting support means for the push-button switch actuator subassemblies, slider switch actuator subassemblies, video camera, transparent shield and the main unit.

22 The apparatus of claim 1, wherein said using solenoid-bracket subassembly to actuate a push-button switch is the method of utilizing electromechanical means to turn on and off a push-button switch on a video camera controller.

23 The apparatus of claim 22, wherein said the method of using a remote controller, which is connected to the PCBA, to control the said solenoid-bracket subassembly to actuate a push-button switch on a video camera controller.

24 The apparatus of claim 22, wherein said the method of using a wireless remote controller, which emits wireless radio frequency signal to a PCBA with radio frequency signal receiver components to control the said solenoid-bracket subassembly to actuate a push-button switch on a video camera controller.

25 The apparatus of claim 1, wherein said the solenoid-bracket subassembly includes a spring return solenoid and a bracket with a slotted mounting hole.

26 The apparatus of claim 25, wherein said the said solenoid is aligned with the center axis of the solenoid perpendicular to the center of the push-button switch on the video camera controller.

27 The apparatus of claim 26, wherein said the plunger of the said solenoid extends out when electrical current is supplied to the solenoid.

28 The apparatus of claim 27, wherein said the said plunger will push against and actuate the push-button switch on the video camera controller.

29 The apparatus of claim 1, wherein said the main unit provides support to mount a video camera controller such that the switches on the said video camera controller are exposed to the solenoid-bracket subassemblies.

30 The apparatus of claim 29, wherein said the main unit provides support to mount a light tunnel, which can be fixed or adjustable light tunnel for IR signal transmission such that the inlet of the said light tunnel covers the IR light source (emitter) of the said video camera controller.

31 The apparatus of claim 1, wherein said the adjustable light channel includes reflective surfaces and mirrors along the internal wall where the IR signals travel through.

32 The apparatus of claim 31, wherein said the light tunnel, which can be fixed or adjustable light tunnel use mirrors to divert the IR signals from the IR light source of the video camera controller to the IR receiver inlet lens of the video camera.

33 The apparatus of claim 32, wherein said the adjustable light tunnel includes a rotary section that can provide a three dimensions diversion of the light vector. Three dimensions diversion is defined as light vector change directions in the XY plane and YZ (or XZ) plane at the same process.

34 The apparatus of claim 32, wherein said the adjustable light channel includes a straight section that is adjustable in length.

35 The apparatus of claim 32, wherein said the method of utilizing a light channel with mirrors to divert the IR signals from the IR light source of the video camera controller to the IR receiver inlet lens of the video camera.

36 The apparatus of claim 35, wherein said the method of utilizing a light channel with a rotary section in claim 33 and includes a straight section that is adjustable in length.

37 The apparatus of claim 35, wherein said the method of using a remote controller, which is connected to the PCBA, to control and actuate a switch on a video camera controller, which in turn emits IR signals and the said IR signals then travel through a light tunnel, which can be fixed or adjustable light tunnel with mirrors to divert the said IR signals from the IR light source of the said video camera controller to the IR receiver inlet lens of the video camera.

38 The apparatus of claim 35, wherein said the method of using a wireless remote controller, which emits wireless radio frequency signal to a PCBA with radio frequency signal receiver components to control and actuate a switch on a video camera controller, which in turn emits IR signals and the said IR signals then travel through a light tunnel, which can be fixed or adjustable light tunnel with mirrors to divert the said IR signals from the IR light source of the said video camera controller to the IR receiver inlet lens of the video camera.

39 The apparatus of claim 1, wherein said the light tunnel, which can be fixed or adjustable light tunnel, has a transparent lens, which can be made of polycarbonate or glass, covering the end opening.

40 The apparatus of claim 39, wherein said this said lens is a cover to prevent foreign substance to enter the said light tunnel.

41 The apparatus of claim 1, wherein said the transparent shield subassembly has at least a portion of the shield made of transparent material like polycarbonate or glass.

42 A method of using a remote control device to remotely controlling the functions of an IR (Infrared) signal remote control device by remotely controlling a PCBA (Printed circuit board assembly) to control at least one solenoid to actuate at least one of the switches of the said IR signal remote control device.

43 A method of using a wireless radio frequency remote control device to remotely controlling the functions of an IR (infrared) signal remote control device by transmitting radio frequency signal to a PCBA (printed circuit board assembly) with radio frequency signal receiver to control at least one solenoid to actuate at least one of the switches of the said IR signal remote control device.
